(19) United States
(12) Patent Application Publication
(10) Pub. No.: US 2011/0200006 A1
(43) Pub. Date: Aug. 18, 2011

(54) HANDOVER METHOD OF MOBILE TERMINAL BETWEEN HETEROGENEOUS NETWORKS

(75) Inventors: Hye Yeon Kwon, Daejeon (KR); Kyung Yul Cheon, Daejeon (KR); Ae Soon Park, Daejeon (KR)

(73) Assignees: KT CORPORATION, Seongnam-city (KR); Electronics and Telecommunications Research Institute, Daejeon (KR)

(21) Appl. No.: 12/809,343

(22) PCT Filed: Sep. 10, 2008
(86) PCT No.: PCT/KR2008/005348

§ 371 Date: Jun. 18, 2010

(30) Foreign Application Priority Data
Dec. 18, 2007 (KR) 10-2007-0133767

(51) Int. Cl. H04W 36/00

(52) U.S. Cl. 370/331

(57) ABSTRACT

The present invention relates to a handover method of a mobile terminal between heterogeneous networks. The present invention may provide a handover method ensuring service continuity between heterogeneous networks by transmitting an IP address of a mobile terminal to a mobile IP management server and activating or inactivating a PDP context when the mobile terminal connected to one of a mobile communication network or a wireless LAN is handed over to the other.

### TECHNICAL FIELD

The present invention relates to a handover method of a mobile terminal between heterogeneous networks, especially which may transmit an IP address of the mobile terminal to a mobility management server to activate or inactivate a PDP context when the mobile terminal connected to a communication network is handed over to another heterogeneous network.

The present invention is a result of study conducted by the Institute for Information Technology Advancement (IITA) under the title of “IT growth engine technology development” [Project serial No. 2005-S-404-33, Project name: 3G Evolution terminal technique development].

### BACKGROUND ART

The development of mobile communication technologies has promoted research on interoperability and handover between heterogeneous networks conforming to RAT (Radio Access Technology). In particular, 3GPP standard-related study groups and IEEE 802 working groups have conducted standardization for interoperability between 3GPP mobile communication networks and wireless LANs. 3GPP suggested the use of wireless LANs as access networks in hot spots instead of 3G mobile communication networks, i.e. UMTS networks.

One advantage of interoperability between the mobile communication network and wireless LAN is to allow for reasonable service fees since areas covered by the mobile communication network, which has generally a wide coverage, overlap areas covered by the wireless LAN, which has generally a narrow coverage, and therefore, service providers may establish communication networks at very cheap costs in hot spots, and distribute users over the networks to reduce communication load.

To receive communication services from both the mobile communication networks and the wireless LANs that are different from each other in access method, mobile terminals should provide a RF (Radio Frequency) interface that can access both of the two networks, as well as technologies such as subscriber authentication, billing, and mobility. However, although the mobile terminal has such a RF interface, a disruption of communication services may occur while the mobile terminal moves between the mobile communication network and the wireless LAN without an effective handover method.

### DISCLOSURE OF INVENTION

### Technical Problem

An aspect of the present invention is to provide an efficient handover method of a mobile terminal between heterogeneous networks without a disruption of communication services while the mobile terminal moves between the networks.

### Technical Solution

To achieve the above object, the present invention provides a handover method including: selecting a mobile communication network for a handover to the mobile communication network by a mobile terminal; requesting a mobile communication service to the selected mobile communication network by the mobile terminal; performing a subscriber authentication procedure of the mobile terminal to provide the mobile communication service requested by the mobile terminal; requesting activation of a PDP context to the mobile communication network by the subscribe-authenticated mobile terminal; assigning a new IP address to the mobile terminal based on the activated PDP context; and handing over the mobile terminal to the mobile communication network based on the newly assigned IP address.

To achieve the above object, the present invention provides a handover method of a mobile terminal including: requesting a connection to a wireless LAN for handover to the wireless LAN by the mobile terminal; performing a subscriber authentication of the mobile terminal to provide a connection to the requested wireless LAN; assigning a new IP address to the mobile terminal by the connected wireless LAN; and handing over the mobile terminal to the wireless LAN based on the newly assigned IP address.

To achieve the above object, the present invention provides a handover method of a mobile terminal connected to a wireless network, if there is an activated PDP context between the mobile terminal and a mobile communication network, the handover method including: requesting inactivation of the PDP context by the mobile terminal; removing the inactivation-requested PDP context; and releasing a connection between the mobile terminal and the mobile communication network based on the removed PDP context.

To achieve the above object, the present invention provides a handover method of a mobile terminal including: connecting the mobile terminal connected to a first network to a second network for handover to the second network; performing a subscriber authentication of the mobile terminal to enable the mobile terminal to receive a service from the second network; requesting a protocol so that the subscriber-authenticated mobile terminal may receive a service from the second network; and handing over the mobile terminal to the second network based on the requested protocol.

### Advantageous Effects

According to the present invention, the mobile terminal that may conduct handover between heterogeneous networks performs a radio access procedure in response to a request of the network selection mechanism, registers an IP address received from a selected network to the mobile IP management server, and inactivates the activated PDP context when moving to the wireless LANs to release the connection to the mobile communication network. This may provide an efficient handover method that ensures a continuity of communication service between heterogeneous networks.

### BRIEF DESCRIPTION OF THE DRAWINGS

FIG. 1 is a construction view schematically illustrating a system to which a handover method of a mobile terminal between heterogeneous networks according to an exemplary embodiment of the present invention may be applied.

FIG. 2 is a construction view specifically illustrating a system to which a handover method of a mobile terminal between heterogeneous networks according to an exemplary embodiment of the present invention may be applied.

FIG. 3 is a flowchart illustrating an exemplary embodiment of the handover method of FIG. 2.

FIG. 4 is a flowchart illustrating another exemplary embodiment of the handover method of FIG. 2.

### BEST MODE FOR CARRYING OUT THE INVENTION

Hereinafter exemplary embodiments will be described in more detail with reference to accompanying drawings.

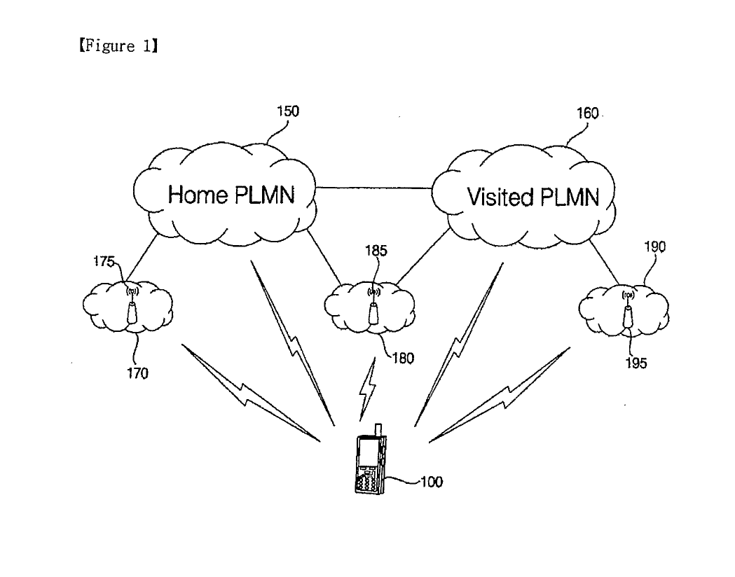

FIG. 1 is a construction view schematically illustrating a system to which a handover method of a mobile terminal between heterogeneous networks according to an exemplary embodiment of the present invention may be applied.

Referring to FIG. 1, the system includes a mobile terminal 100, a PLMN (Public Land Mobile Network) 150 and 160, and a wireless LAN access network 170, 180, and 190. The PLMN refers to a mobile communication network that communicates with a base station. For example, the mobile communication network may include 3G mobile communication network.

The mobile terminal 100 includes a mobile communication interface that can be connected to the PLMN 150 and 160, and a wireless LAN interface that can be connected to the wireless LAN access network 170, 180, and 190. The mobile terminal 100 may also include a wireless communication interface that can be connected to both the mobile communication network 150 and 160 and the wireless LAN access network 170, 180, and 190.

The mobile terminal 100 is connected and registered to the mobile communication network 150 and 160 or wireless LAN access network 170, 180, and 190 via a core network (CN). Also, the mobile terminal 100 is authorized to communicate with the networks 150, 160, 170, 180, and 190 via the CN, and receives mobile communication services and wireless LAN communication services from the mobile communication network 150 and 160 or wireless LAN access network 170, 180, and 190 via the CN. The CN refers to a network that is connected, for example, to a mobile communication network, a wireless LAN access network, and the Internet to communicate signals to them.

For example, when the mobile terminal 100 requests a voice communication service to the CN, the CN provides the mobile terminal 100 with a voice communication service via a circuit-switched support node and a circuit-switched gateway, and when the mobile terminal 100 requests a packet communication service to the CN, the CN provides the mobile terminal 100 with a packet communication service via a packet-switched support node and a packet-switched gateway.

The wireless LAN access network 170, 180, and 190 includes at least one access point 175, 185, and 195 that enables the mobile terminal 100 to access the wireless LAN access network 170, 180, and 190, respectively. The mobile terminal 100 connected to the access point 175, 185, and 195 may receive a wireless communication service. The wireless LAN access network 170, 180, and 190 may be connected to at least one mobile communication network 150 and 160.

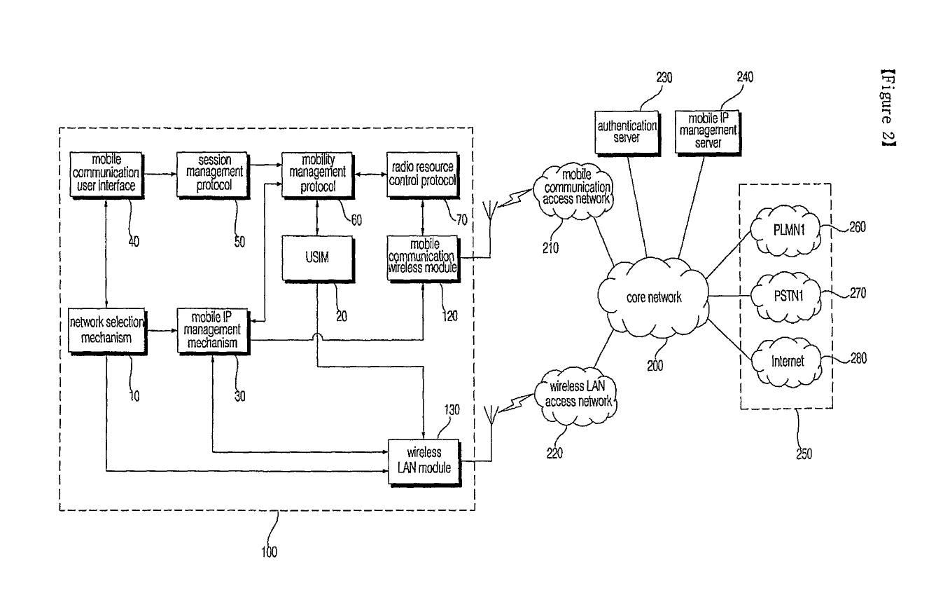

FIG. 2 is a construction view specifically illustrating a system to which a handover method of a mobile terminal between heterogeneous networks according to an exemplary embodiment of the present invention may be applied.

Referring to FIG. 2, the system includes a mobile terminal 100, a core network 200, a mobile communication access network 210, a wireless LAN access network 220, an authentication server 230, a mobile IP management server 240, and an external network 250.

The mobile terminal 100 includes a mobile communication wireless module 120 that may communicate with the mobile communication access network 210, a wireless LAN module 120 that may communicate with the wireless LAN access network 220, a network selection mechanism 10, a universal subscriber identity module (USIM) 20, a mobile IP management mechanism 30, a mobile communication user interface (UI) 40, a session management protocol 50, a mobility management protocol 60, and a radio resource management protocol 70.

The network selection mechanism 10 is a program that selects an access to the mobile communication access network 210 or an access to the wireless LAN access network 220 according to access environment of the mobile terminal 100. Various hierarchies of triggering algorithms may be used for the network selection mechanism 10. For example, the network selection mechanism 10 measures the sensitivity of signals transmitted from the wireless LAN access network 220. If the signal sensitivity is strong, the network selection mechanism 10 may select the access to the wireless LAN access network 220, and if the signal sensitivity is weak, the network selection mechanism 10 may select the access to the mobile communication access network 210.

The USIM 20 is a module that manages subscriber information of the mobile communication service. The USIM 20 may store the subscriber information and authentication values including algorithms related to the subscriber authentication.

The mobile IP management mechanism 30 is a program that prevents the release of the mobile communication service caused by alteration of IP address occurring when the mobile terminal 100 hands over from a current accessing network to another network. For example, a universal mobile IP protocol may be used for the mobile IP management mechanism 30 that enables the mobile communication service to be maintained even though the current IP address changed to another one due to handover to the other networks.

The network selection mechanism 10, the USIM 20, and the mobile IP management module 30 are modules necessary to access the mobile communication network or wireless LAN network.

The mobile communication UI 40 enables a user to set parameters for call process, handle menus, and interface with low-level protocols and high-level application service programs.

The session management protocol 50 is a mobile communication SM (Session Management) protocol that generates, corrects, or deletes a session in response to a request from a high-level application service. The session management protocol 50 is managed as a PDP (Packet Data Protocol) context. The session management protocol 50 may also set QoS (Quality of Service) on a wireless bearer, and provide a mapping of QoS with the external network 260.

The PDP context is a network protocol, such as IP, which is used by an external packet data network to communicate with a GPRS (General Packet Radio Service) network. The PDP context refers to information describing mobile communication service signals or sessions (for example, billing ID). The PDP context is used to identify sessions at a mobile station in the GPRS network.

The PDP context may include a PDP type, a PDP address, usage information of static address and dynamic address, transaction information, and QoS related information. The PDP context may follow X.25, point-to-point protocols (PPP), IPv4 (Internet Protocol version 4), or IPv6 (Internet Protocol version 6). When the PDP context is activated, a path for packet switching may be established, and the mobile terminal 100 may be assigned an IP address.

The mobility management protocol 60 is a mobile communication GMM (GPRS Mobility Management) protocol that performs the registration of a communication network for packet communication service and the location of the mobile terminal 100, subscriber authentication, and password setup, and creates and manages a connection between the mobile terminal 100 and the communication network.

The radio resource control protocol 70 is a mobile communication RRC (Radio Resource Control) protocol that receives system information signals periodically transmitted from the communication network, and assigns and withdraws a radio resource. The radio resource control protocol 70 may also set, correct, and cancel low-level protocol attributes, and transmit a network-hierarchical message to the mobile terminal 100.

The CN 200 is a communication network that deals with switching, routing, and data access to the external network 260. The CN 200 provides a communication service to the mobile terminal 100 via the mobile communication access network 210 or wireless LAN access network 220 according to network access environment of the mobile terminal 100. The CN 200 is connected to the authentication server 230 and mobile IP management server 240 to send data transmitted from the authentication server 230 and mobile IP management server 240 to the mobile terminal 100 using the mobile communication access network 210 or the wireless LAN access network 220.

The mobile communication access network 210 is a network that may provide voice and data communication services, for example, by WCDMA (Wideband Code Division Multiple Access) technologies. The mobile communication access network 210 includes one or more connection nodes connected to the mobile terminal 100.

The wireless LAN access network 220 includes at least one access point to enable the mobile terminal 100 to provide a wireless service to the mobile terminal 100.

The mobile communication access network 210 and wireless LAN access network 220 are connected to the CN 200 to provide security, billing, and other mobility-related services to the mobile terminal 100.

The authentication server 230 is in charge of subscriber authentication of the mobile terminal 100. The authentication server 230 performs the subscriber authentication using subscriber information transmitted from the USIM 20 included in the mobile terminal 100.

The mobile IP management server 240 assigns an IP address to the mobile terminal 100. When the IP address changes into another as the mobile terminal 100 is reconnected to the communication network or handed over to another communication network, the mobile IP management server 240 manages the changed IP address.

The external network 250 is a public communication network including the PLMN 260, PSTN (Public Switched Telephone Network) 270, and the Internet 280. The mobile terminal 100 may be connected to the external network 250 via the CN 200.

In handover, when the mobile terminal 100 powers on, the mobile terminal 100 recognizes the mobile communication access network 210, establishes a connection with the mobile communication access network 210, and tries to register itself to the CN 200.

Next, when receiving a registration request from the mobile terminal 100, the authentication server 230 transmits authentication parameters for subscriber authentication to the mobile terminal 100 using the CN 200, and the USIM 20 of the mobile terminal 100 performs an authentication algorithm using the authentication parameters.

Then, the result of authentication is transmitted to the authentication server 230, which in turn compares the authentication result with authentication information stored in the authentication server 230. In case that the authentication result matches the stored authentication information, the authentication process is complete.

Subsequently, after the subscriber authentication has been complete, the mobile IP management server 240 assigns an IP address to the mobile terminal 100, and the mobile terminal 100 registers the altered IP address to the mobile IP management server 240.

In case that the mobile terminal 100 connected to the mobile communication access network 210 is handed over to the wireless LAN access network 220, the network selection mechanism 10 of the mobile terminal 100 requests a wireless LAN association with the wireless LAN access network 220 through the wireless LAN module 130.

Next, the wireless LAN access network 220 having received the wireless LAN association request from the mobile terminal 100 requests a subscriber authentication to the authentication server 230 through the CN 200.

Then, the authentication server 230 transmits the authentication parameters for subscriber authentication to the mobile terminal 100 via the CN 200, and the USIM 20 of the mobile terminal 100 performs an authentication algorithm using the authentication parameters.

Subsequently, the result of the authentication is transmitted to the authentication server 230, and the authentication server 230 compares the result with the authentication information stored in the authentication server 230. In case that the result matches the stored authentication information, the authentication process is complete.

Next, after the subscriber authentication has been complete, the wireless LAN access network 220 allows the mobile terminal 100 to access it, and assigns a new IP address to the mobile terminal 100.

When the mobile terminal 100 is assigned a new IP address from the wireless LAN access network 220, the network selection mechanism 10 of the mobile terminal 100 requests registration of the new IP address to the mobile IP management server 240 using the mobile IP management mechanism 30.

Then, the mobile terminal 100 may communicate with the external network 260 in a wireless LAN mode via the wireless LAN access network 220 and the CN 200 using the new IP address. In this case, the mobile communication access network 210 is unaware of handover of the mobile terminal 100, and therefore, the network selection mechanism 10 of the mobile terminal 100 inactivates the PDP context between the CN 200 and the mobile terminal 100 using the session management protocol 50 to remove the connection between the mobile communication access network 210 and the mobile terminal 100 and hold the mobile terminal 100 at standby state.

On the other hand, in case that the mobile terminal 100 connected to the wireless LAN access network 220 is handed over to the mobile communication access network 210, a wireless connection setup procedure starts, which activates the PDP context using the mobile communication wireless module 120.

Next, a wireless connection to the mobile communication access network 220 is requested and the authentication server 230 performs a subscriber authentication process using the USIM 20.

After the subscriber authentication process has been complete, the CN 200 generates a new IP address and transmits the new IP address and a response to the PDP context activation request to the mobile terminal 100.

The mobile terminal 100 registers the new IP address to the mobile IP management server 240, and the handover procedure is complete.

The CN 200 may be a CN for 3 G communication. The mobile communication access network 210 may be a 3G access network or UTRAN (UMTS Terrestrial Radio Access Network). That is, the present invention may apply to a method of interlocking 3G networks to the wireless LAN networks.

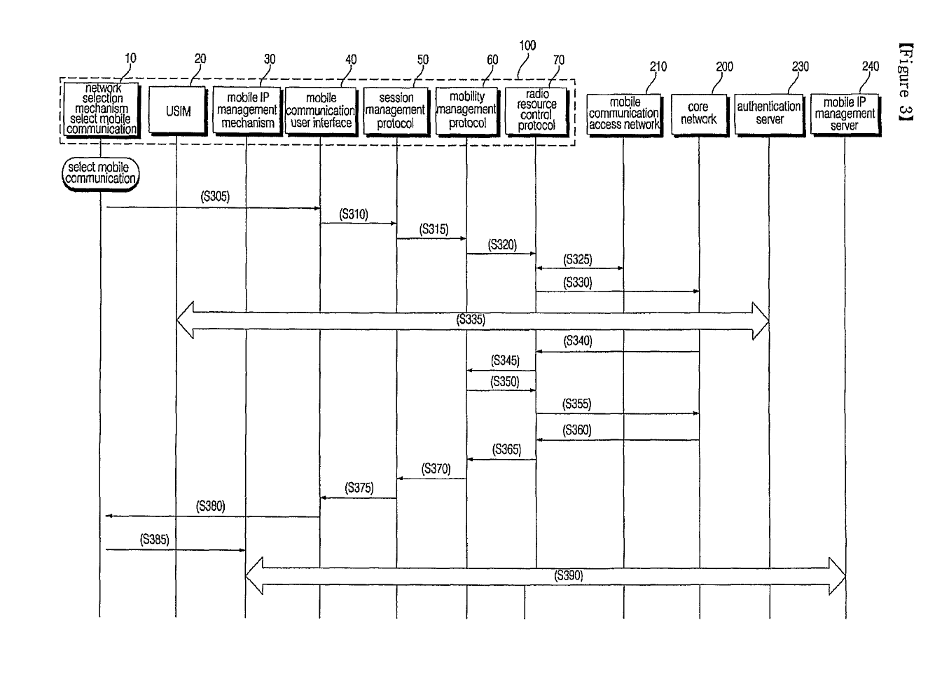

FIG. 3 is a flowchart illustrating an exemplary embodiment of the handover method of FIG. 2, wherein the mobile terminal 100 connected to the wireless LAN access network 220 is handed over to the mobile communication access network 210.

Referring to FIG. 3, firstly, the network selection mechanism 10 of the mobile terminal 100 selects a connection to the mobile communication access network 210 (step S300).

Next, the selection mechanism 10 requests handover to the mobile communication access network 210 to the user interface 40 (step S305), and the user interface 40 requests the activation of the PDP context to the session management protocol 50 (step S310).

The 50 transmits the activation request of the PDP context transmitted from the user interface 40 to the mobility management protocol 60 (step S315), and the mobility management protocol 60 requests a mobile communication service to the radio resource management protocol 70 in response to the activation request of the PDP context (step S320).

Next, the radio resource management protocol 70 establishes a mobile communication connection with the mobile communication access network 210 using the 120 (step S325), and requests a mobile communication service to the CN 200 (step 330).

Subsequently, when the CN 200 requests a subscriber authentication to the authentication server 230, the authentication server 230 performs a subscriber authentication procedure using the USIM 20 (step S335), and the authentication result is transmitted to the 200.

If the subscriber authentication is success, the CN 200 transmits a response to the mobile communication service request to the radio resource management protocol 70 (step S340), and the radio resource management protocol 70 transmits the response to the MCS request to the mobility management protocol 60 (step S345).

When receiving the response to the MCS request from the 200, the mobility management protocol 60 requests the PDP context activation to the radio resource management protocol 70 (step S350), and the radio resource management protocol 70 transmits the received PDP context activation request to the CN 200 (step S355).

Next, the CN 200 transmits a response message to the PDP context activation request to the radio resource management protocol 70 (step S360).

When the PDP context is activated, the mobile terminal 100 is assigned a dynamic address besides the static address that has been previously assigned to the mobile terminal 100. The dynamic address may be assigned by a GGSN (Gateway GPRS Support Node). The “GGSN” refers to a node responsible for connection between backbone networks and external packet data networks. The GGSN may convert GPRS packets transmitted from a SGSN (Serving GPRS Support Node) into an appropriate PDP format (for example, IP, X.25) and convert the PDP address of the receiving packet data into addresses for receivers. The “SGSN” is a node responsible for data packet communication with mobile stations in a service area. The SGSN may perform packet routing and packet sending, mobility management, logical link management, authentication, and billing.

That is, if the PDP context is activated, a session is set for the mobile terminal 100, and this enables data communication. The PDP context activation request provided by the session management protocol 50 in step S315 is transmitted to the GGSN via the SGSN of the 200, the dynamic address included in the PDP context is assigned to the mobile terminal 100 by the GGSN, the PDP context response message is transmitted to the SGSN, and the activated PDP context is transmitted to the mobile terminal 100 by the GGSN. By doing so, a session setup procedure is complete.

Next, the response message to the PDP context activation request transmitted from the CN 200 is transmitted through the mobility management protocol 60 (step S365) to the session management protocol 50 (step S370).

Then, the session management protocol 50 completes the session setup procedure based on information such as dynamic address and address format included in the response message to the PDP context activation, and then transmits the session information to the user interface 40 (step S375).

Next, the user interface 40 informs the selection mechanism 10 that the PDP context has been activated and a session has been installed (step S380), and the selection mechanism 10 requests the mobile IP management to the mobile IP management mechanism 30 (S385). At this time, information on location of the node connected to the mobile terminal 100 for managing the mobility of the mobile terminal 100 is stored at the GGSN of the mobile communication access network 210, and information on location of the node which varies with the movement of the mobile terminal 100 is transmitted to the GGSN by the SGSN.

When receiving the mobile IP management request from the 10, the mobile IP management server 240 transmits the IP address included in the PDP context activation response message received in step S360 to the mobile IP management server 240 (step S390). If the IP address is registered to the 240, the mobile terminal 100 is handed over from the wireless LAN access network 220 to the mobile communication access network 210 to be able to receive communication services.

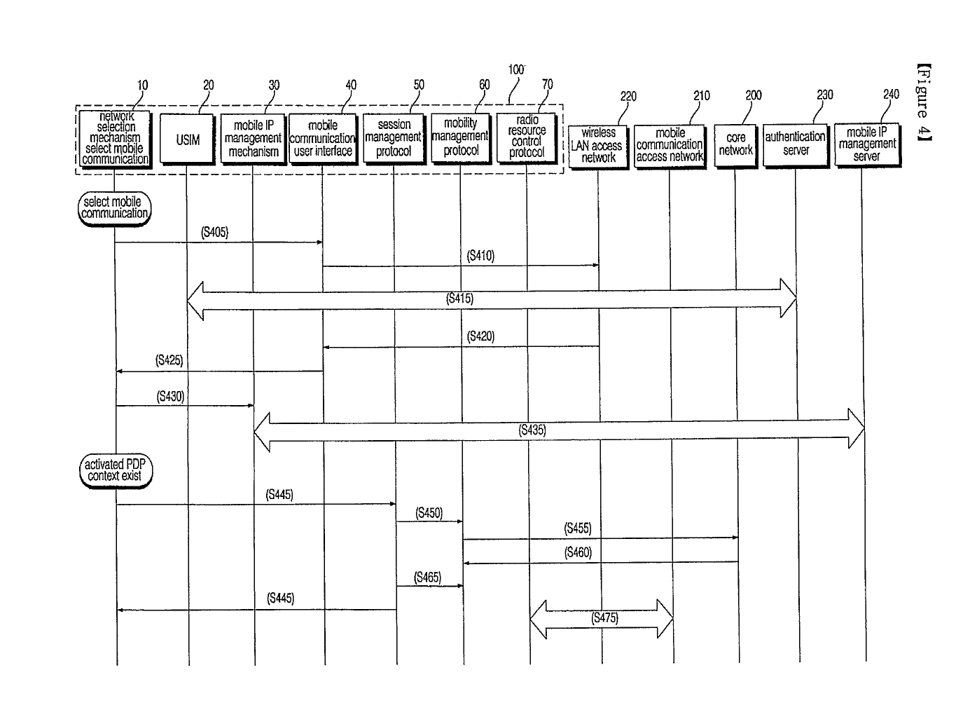

FIG. 4 is a flowchart illustrating another exemplary embodiment of the handover method of FIG. 2, wherein the mobile terminal 100 having been connected to the mobile communication access network 210 is handed over to the wireless LAN access network 220.

Referring to FIG. 4, firstly, the network selection mechanism 10 of the mobile terminal 100 selects a connection to the wireless LAN access network 220 (step S400). In this case, the selection mechanism 10 senses a signal sensitivity between the mobile terminal 100 and the wireless LAN access network 220, and if the signal sensitivity is more than a prescribed value, the selection mechanism 10 may select a connection to the wireless LAN access network 220.

Next, the selection mechanism 10 requests handover to the wireless LAN access network 220 to the wireless LAN module 130 (step S405), and requests an association to the wireless LAN access network 220 through the wireless LAN module 130 to the wireless LAN access network 220 (step 410).

Subsequently, when the CN 200 requests a subscriber authentication of the mobile terminal 100 to the authentication server 230, the authentication server 230 performs a subscriber authentication procedure using the USIM 20 of the mobile terminal 100 (step S415.). The location information of the access point 175, 185, and 195 to be connected to the mobile terminal 100 may be recognized by the SGSN of the wireless LAN access network 220 and stored at the GGSN.

If the subscriber authentication is success, the wireless LAN access network 220 assigns a new IP address generated due to handover to the mobile terminal 100, and transmits the result of handover to the selection mechanism 10 through the wireless LAN module 130 (steps S420 and S425).

When recognizing the handover to the wireless LAN access network 220, the selection mechanism 10 requests a mobile IP management to the mobile IP management mechanism 30 (step S430).

Next, the mobile IP management mechanism 30 transmits the new IP address to the mobile IP management server 240 (step S435). If the mobile IP management server 240 stores the IP address assigned to the mobile terminal 100, the wireless LAN access network 220 may provide communication services to the mobile terminal 100 in a wireless LAN mode using the IP address.

Next, if the IP address registration procedure is complete, the selection mechanism 10 of the mobile terminal 100 determines whether there is an activated PDP context between the mobile terminal 100 and the mobile communication access network 210 (step S440).

If there is an activated PDP context between the mobile terminal 100 and the mobile communication access network 210, the selection mechanism 10 requests PDP context inactivation to the user interface 40 (step S445).

If the user interface 40 transmits the PDP context inactivation request message to the session management protocol 50 (step S450), the session management protocol 50 requests the PDP context inactivation to the CN 200 (step S455).

Next, the CN 200 removes the PDP context for the mobile terminal 100 out of the CN 200 and the mobile communication access network 210, and transmits a response message to the PDP context inactivation request to the session management protocol 50 through the radio resource management protocol 70 and the mobility management protocol 60 (step S460).

Then, the session management protocol 50 transmits the response message to the PDP context inactivation request to the selection mechanism 10 through the user interface 40 (steps S465 and S470).

Next, the radio resource management protocol 70 removes the mobile communication connection with the mobile communication access network 210, and the mobile terminal 100 enters into an idle state (step S475). In the idle state, the mobile terminal 100 maintains power-on, and the mobile terminal 100 may perform paging and mobility management. However, in the idle state, it is impossible to communicate data between the mobile terminal 100 and the mobile communication access network 210. Subsequently, the mobile terminal 100 may use communication services through the wireless LAN.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

### INDUSTRIAL APPLICABILITY

In a case where the mobile terminal moves between two different networks, the present invention may efficiently hand over the mobile terminal from a network to another without any disconnection of communication services.

1. A handover method comprising:
selecting a mobile communication network for a handover to the mobile communication network by a mobile terminal;
requesting a mobile communication service to the selected mobile communication network by the mobile terminal;
performing a subscriber authentication procedure of the mobile terminal to provide the mobile communication service requested by the mobile terminal;
requesting activation of a PDP context to the mobile communication network by the subscribe-authenticated mobile terminal;
assigning a new IP address to the mobile terminal based on the activated PDP context; and
handing over the mobile terminal to the mobile communication network based on the newly assigned IP address.

2. The handover method of claim 1, wherein
the PDP context includes at least one of a PDP type, a PDP address, usage information of static address and dynamic address, transaction information, QoS related information.

3. The handover method of claim 1, wherein
The type of the PDP context is one of X.25, PPP, IPv4, and IPv6.

4. The handover method of claim 1, wherein
said performing the subscriber authentication procedure includes performing an authentication of the mobile terminal using subscriber information received from the mobile terminal.

5. The handover method of claim 1, wherein
said handing over the mobile terminal includes performing the handover by transmitting and registering the newly assigned IP address to the mobile communication network.

6. A handover method of a mobile terminal comprising:
requesting a connection to a wireless LAN for handover to the wireless LAN by the mobile terminal;
performing a subscriber authentication of the mobile terminal to provide a connection to the requested wireless LAN;
assigning a new IP address to the mobile terminal by the connected wireless LAN; and
handing over the mobile terminal to the wireless LAN based on the newly assigned IP address.

7. The handover method of claim 6, wherein
said performing the subscriber authentication procedure includes performing an authentication of the mobile terminal using subscriber information received from the mobile terminal.

8. The handover method of claim 6, wherein
said handing over the mobile terminal includes performing the handover by transmitting and registering the newly assigned IP address to the wireless LAN.

9. A handover method of a mobile terminal connected to a wireless network, if there is an activated PDP context between the mobile terminal and a mobile communication network, the handover method comprising:
requesting inactivation of the PDP context by the mobile terminal;
removing the inactivation-requested PDP context; and
releasing a connection between the mobile terminal and the mobile communication network based on the removed PDP context.

10. The handover method of claim 9, wherein
said releasing includes performing paging and mobility management between the mobile terminal and the mobile communication network.

11. The handover method of claim 9, wherein
the PDP context includes at least one of a PDP type, a PDP address, usage information of static address and dynamic address, transaction information, QoS related information.

12. The handover method of claim 9, wherein
The type of the PDP context is one of X.25, PPP, IPv4, and IPv6.

13. A handover method of a mobile terminal comprising:
connecting the mobile terminal connected to a first network to a second network for handover to the second network;
performing a subscriber authentication of the mobile terminal to enable the mobile terminal to receive a service from the second network;
requesting a protocol so that the subscriber-authenticated mobile terminal may receive a service from the second network; and
handing over the mobile terminal to the second network based on the requested protocol.

14. The handover method of claim 13, wherein
said handing over the mobile terminal includes performing a handover by enabling the second network to assign a new IP address to the mobile terminal and registering the newly assigned IP address to the second network.

15. The handover method of claim 13, wherein
the protocol is a PDP context.

16. The handover method of claim 15, wherein
the PDP context includes at least one of a PDP type, a PDP address, usage information of static address and dynamic address, transaction information, QoS related information.

17. The handover method of claim 15, wherein
The type of the PDP context is one of X.25, PPP, IPv4, and IPv6.
